(19) United States
(12) Patent Application Publication
(10) Pub. No.: US 2011/0276929 A1
(43) Pub. Date: Nov. 10, 2011

(54) DESIGNING APPARATUS, DESIGNING METHOD, AND COMPUTER READABLE MEDIUM STORING DESIGNING PROGRAM

(75) Inventor: Hiroshi Imai, Hatogaya-shi (JP)

(73) Assignee: Kabushiki Kaisha Toshiba, Tokyo (JP)

(21) Appl. No.: 12/982,770

(22) Filed: Dec. 30, 2010

(30) Foreign Application Priority Data
May 10, 2010 (JP) 2010-108357

(51) Int. Cl. G06F 17/50

(52) U.S. Cl. 716/102

(57) ABSTRACT

A designing apparatus is used with a simulator simulating a behavior description describing behavior of a semiconductor integrated circuit, and a high-level synthesis apparatus allocating a variable described in the behavior description to a register and generating a register transfer level description based on the allocated variable. The apparatus includes an input module, a calculation module, and an estimation module. The input module inputs a simulation result of the simulator and a binding result comprising a variable name of the allocated variable to be stored into the register. The calculation module calculates a rate of change of the allocated variable to be stored into the register in one clock cycle based on the simulation result and the binding result. The estimation module estimates power consumption of the semiconductor integrated circuit corresponding to the behavior description based on the rate.

### CROSS REFERENCE TO RELATED APPLICATIONS

This application is based upon and claims the benefit of priority from the prior Japanese Patent Application No. 2010-108357, filed on May 10, 2010, the entire contents of which are incorporated herein by reference.

### FIELD

The present invention relates to a designing apparatus, a designing method, a computer readable medium storing a designing program.

### BACKGROUND

In recent years, high-level designing for designing large-scale semiconductor integrated circuits (hereinafter referred to as “LSIs (Large Scale Integration)”) with a higher level of abstraction than a register transfer level (hereinafter referred to as the “RTL”) has been employed in order to improve the efficiency of designing the LSIs. In the high-level designing, the behavior of each LSI is checked through a simulation of a behavior description that describes the behavior of each LSI, and a RTL description is synthesized from the behavior description with the use of a high-level synthesis tool.

To reduce power consumption of a LSI, it is necessary to examine various circuit structures. In the high-level designing, a RTL description is synthesized from a behavior description with the use of a high-level synthesis tool, thereby examining a circuit structure with desired power consumption.

However, power consumption is conventionally estimated by a simulation of a netlist that is obtained from a RTL description synthesized by a high-level synthesis tool. In such a simulation of a netlist, a large amount of data is dealt with. Therefore, an extremely long period of time is required to estimate the power consumption by a simulation of a netlist. As a result, the efficiency in LSI designing becomes lower.

### BRIEF DESCRIPTION OF THE DRAWINGS

FIG. 1 is a block diagram showing the structure of a designing system 1 that includes the designing apparatus 10 according to the first embodiment.

FIG. 2 is a block diagram specifically showing the structures of the designing apparatus 10 and a high-level synthesis apparatus 30 of FIG. 1.

FIG. 3 illustrates an example of a behavior description 91 of FIG. 1.

FIG. 4 illustrates an example of a simulation result 93 of FIG. 1.

FIG. 5 illustrates an example of a scheduling result of a scheduler 31 of FIG. 2.

FIG. 6 illustrates an example of a binding result 94 of FIG. 1.

FIG. 7 is a flowchart showing the procedures in an estimating operation to be performed by the designing apparatus 10 of FIG. 1.

FIG. 8 is a flowchart showing the procedures in the step of generating register table (S702) of FIG. 7.

FIG. 9 is a schematic view of the register table.

FIG. 10 is a flowchart showing the procedures in a monitoring operation according to the second embodiment.

### DETAILED DESCRIPTION

Embodiments will now be explained with reference to the accompanying drawings.

According to one embodiment, a designing apparatus is used with a simulator simulating a behavior description describing behavior of a semiconductor integrated circuit, and a high-level synthesis apparatus allocating a variable described in the behavior description to a register and generating a register transfer level description based on the allocated variable. The apparatus includes an input module, a calculation module, and an estimation module. The input module inputs a simulation result of the simulator and a binding result comprising a variable name of the allocated variable to be stored into the register. The calculation module calculates a rate of change of the allocated variable to be stored into the register in one clock cycle based on the simulation result and the binding result. The estimation module estimates power consumption of the semiconductor integrated circuit corresponding to the behavior description based on the rate.

### First Embodiment

The following is a detailed description of a first embodiment, with reference to the accompanying drawings.

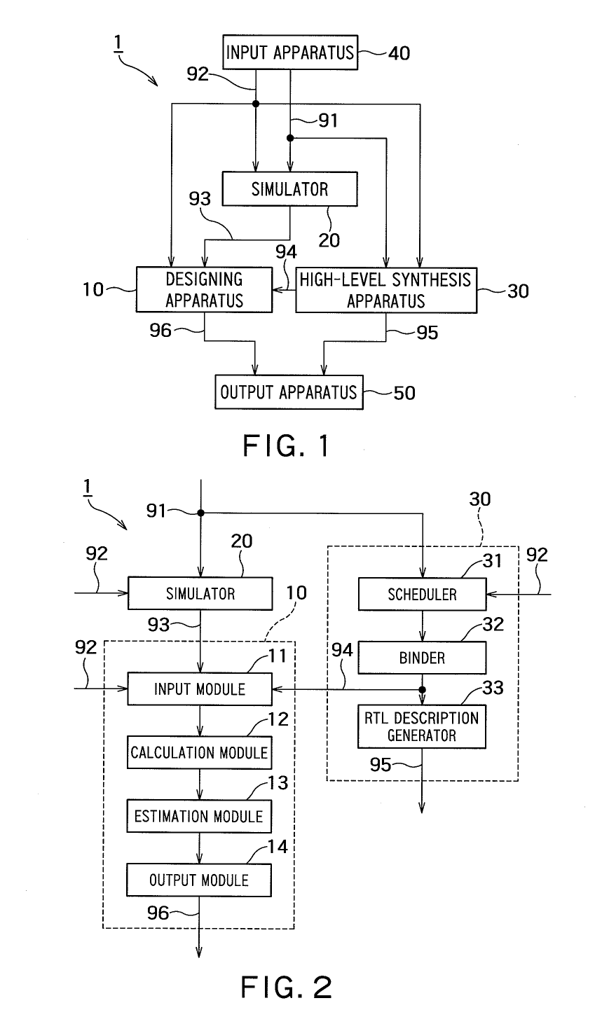

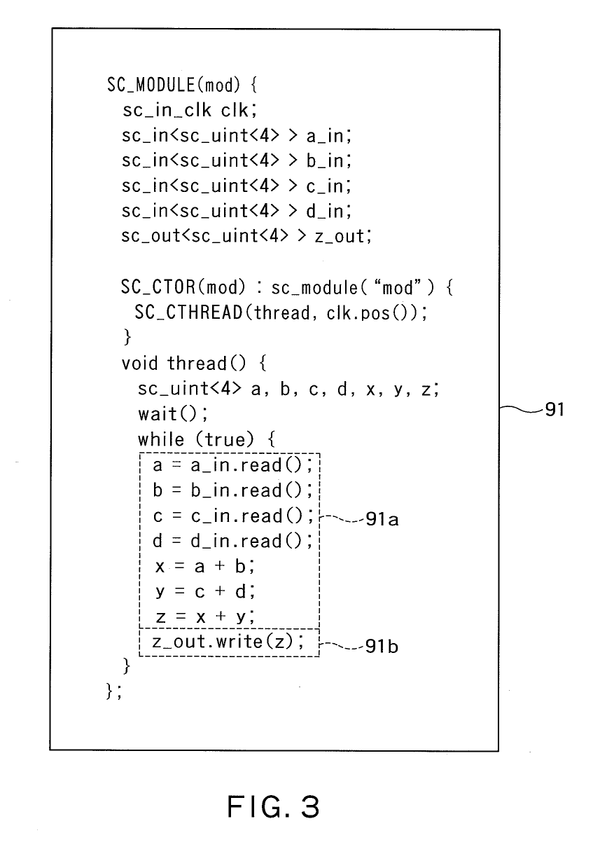

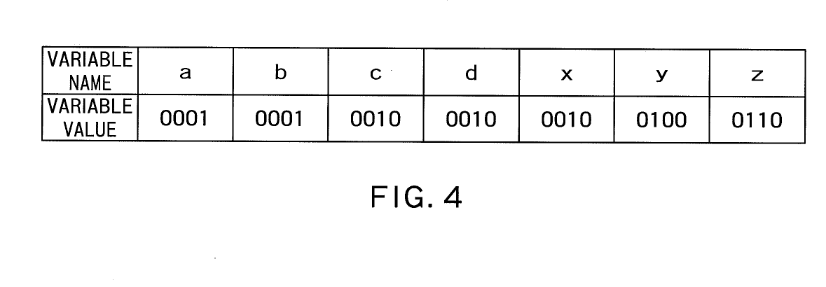

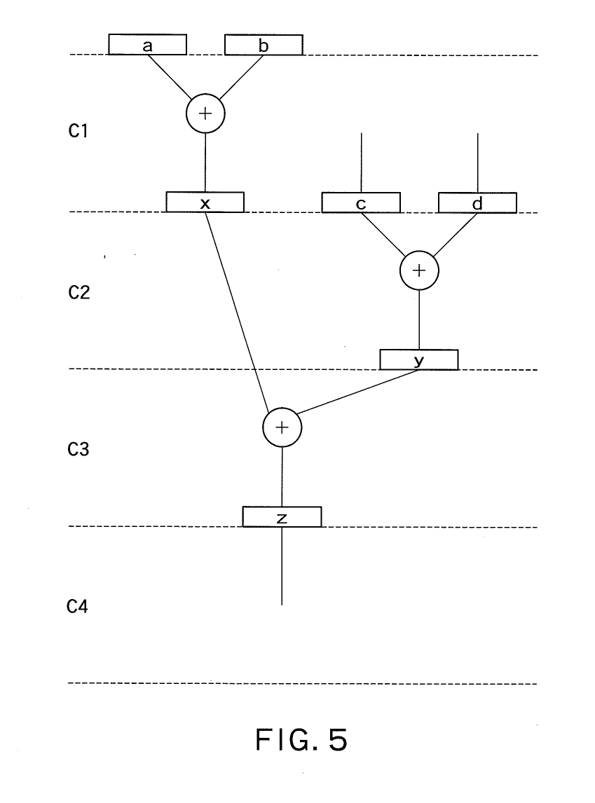

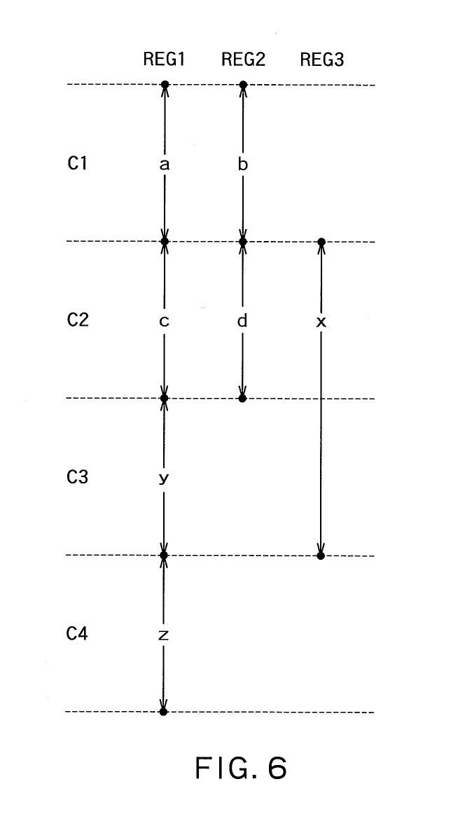

The structure of a designing apparatus according to the first embodiment is explained. FIG. 1 is a block diagram showing the structure of a designing system 1 that includes the designing apparatus 10 according to the first embodiment. FIG. 2 is a block diagram specifically showing the structures of the designing apparatus 10 and a high-level synthesis apparatus 30 of FIG. 1. FIG. 3 illustrates an example of a behavior description 91 of FIG. 1. FIG. 4 illustrates an example of a simulation result 93 of FIG. 1. FIG. 5 illustrates an example of a scheduling result of a scheduler 31 of FIG. 2. FIG. 6 illustrates an example of a binding result 94 of FIG. 1.

As illustrated in FIG. 1, the designing system 1 according to the first embodiment includes the designing apparatus 10, simulator 20, the high-level synthesis apparatus 30, an input apparatus 40, and an output apparatus 50. The simulator 20 and the high-level synthesis apparatus are connected to the designing apparatus 10. The designing apparatus 10, the simulator 20, and the high-level synthesis apparatus 30 are connected to the input apparatus 40. The designing apparatus 10 and the high-level synthesis apparatus 30 are connected to the output apparatus 50. The input apparatus 40 is a keyboard, and the output apparatus 50 is a display or a database, for example.

The simulator 20 of FIG. 1 performs a simulation of the behavior description 91 that describes behavior of a LSI in order of procedures. Specifically, the simulator 20 receives the behavior description 91 and a command 92 from the input apparatus 40. The command 92 contains various kinds of information required for the simulation. For example, the behavior description 91 includes variable codes 91a that define variables, and output codes 91b that define output signals, as shown in FIG. 3. As described in the behavior description 91 of FIG. 3, four values that are inputted from outside the LSI are allocated to variables having the variable names “a” through “d”, respectively. The arithmetic operation “x=a+b”, “y=c+d”, and “z=x+y” are performed with respect to those four variables having the variable names “a” through “d”. The variable value having the variable name “z” is outputted as a result of the arithmetic operation to the outside of the LSI. In the behavior description 91 of FIG. 3, “a_in.read ( )” is assigned to the variable having the variable name “a”, “b_in.read ( )” is assigned to the variable having the variable name “b”, “c_in.read ( )” is assigned to the variable having the variable name “c”, “d_in.read ( )” is assigned to the variable having the variable name “d”, “a+b” is assigned to a variable having the variable name “x”, “c+d” is assigned to a variable having the variable name “y”, and “x+y” is assigned to the variable having the variable name “z”. In the behavior description 91 of FIG. 3, the output signal is defined as “z_out.write(z)”, and therefore, the value of the output signal is the variable value having the variable name “z”. The simulation result 93 is sent to an input module 11 of the designing apparatus 10 shown in FIG. 2. The simulation result 93 of FIG. 4 indicates the variable values having the variable names “a” and “b” are “0001”, the variable values having the variable names “c”, “d”, and “x” are “0010”, variable value having the variable name “y” is “0100”, and the variable value having the variable name “z” is “0110”. Accordingly, the value of the output signal of the LSI corresponding to the behavior description 91 of FIG. 3 is “0110”.

The high-level synthesis apparatus 30 of FIG. 1 performs a scheduling operation to determine clock cycles in which the arithmetic operation described in the behavior description 91 is to be performed. Based on the result of the scheduling operation, the high-level synthesis apparatus 30 performs a binding operation to allocate the variables described in the behavior description 91 to registers. Based on the result of the binding operation, the high-level synthesis apparatus 30 generates a RTL description 95. As shown in FIG. 2, the high-level synthesis apparatus 30 includes the scheduler 31, a binder 32, and a RTL description generator 33.

The scheduler 31 of FIG. 2 performs the scheduling operation to determine clock cycles in which the arithmetic operation described in the behavior description 91 is to be performed. The algorithm used by the scheduler 31 is an arbitrary algorithm such as ASAP (As Soon As Possible) or ALAP (As Late As Possible). Specifically, the scheduler 31 receives the behavior description 91 and the command 92 from the input apparatus 40.

The command 92 contains various kinds of information required for high-level synthesis. The scheduler 31 analyzes the behavior description 91 to generate a control data flow graph (hereinafter referred to as the “CDFG”). The CDFG contains the variable name, arithmetic operations, and clock cycles. In the CDFG of FIG. 5, the circles containing arithmetic symbols represent the arithmetic operations described in the behavior description 91, the lines between the arithmetic operations represent data flows, the rectangles containing the variables having the variable names “a” through “c” and “x” through “z” represent the storage of data into registers, the broken lines represent the boundaries between the clock cycles, and C1 through C4 are the labels of the clock cycles. In FIG. 5, the variable values having the variable names “a” and “b” are stored into the registers before the clock cycle C1. In the clock cycle C1, the variable values having the variable name “a” and “b” are added to generate the variable value having the variable name “x”, and the variable values having the variable names “c”, “d”, and “x” are stored into the registers. In the clock cycle C2, the variable values having the variable names “c” and “d” are added to generate the variable value having the variable name “y”, and the variable value having the variable name “y” is stored into the registers. The variable value having the variable name “x” stored into the register in the clock cycle C1 is held. In the clock cycle C3, the variable values having the variable names “x” and “y” are added to generate variable value having the variable name “z”, and the variable value having the variable name “z” is stored into the registers. In the clock cycle C4, the variable value having the variable name “z” stored into the register in the clock cycle C3 is held.

Based on the CDFG generated by the scheduler 31, the binder 32 of FIG. 2 performs the binding operation to allocate the circuit components for realizing the behavior of the LSI expressed by the CDFG. The algorithm of the binder 32 is an arbitrary algorithm such as a left edge algorithm. Specifically, the binder 32 assigns the arithmetic operations in the CDFG to arithmetic units, and assigns the transfers of variables (the variable names and the variable values) among at least two clock cycles in the CDFG to the registers. A binding result 94 contains the register names, the variable names, and the clock cycles. The binding result 94 is sent to a calculation module 12 of the designing apparatus 10 and the RTL description generator 33. The binding result 94 of FIG. 6 is a binding result concerning the transfers of variables among the clock cycles in the CDFG. In FIG. 6, REG1 through REG3 are the labels of the registers, the broken lines represent the boundaries between the clock cycles, C1 through C4 are the labels of the clock cycles, the solid-line arrows represent the periods of time during which values are held in the respective registers, and the alphabets in the solid-line arrows indicate the variable names corresponding to the variable values held in the registers. In other words, the binding result 94 indicates registers to which the respective variables in the behavior description 91 are allocated. In FIG. 6, in the clock cycle C1, the variable value having the variable name “a” is held in the register REG1, and the variable value having the variable name “b” is held in the register REG2. In the clock cycle C2, the variable value having the variable name “c” is held in the register REG1, the variable value having the variable name “d” is held in the register REG2, and the variable value having the variable name “x” is held in the register REG3. In the clock cycle C3, the variable value having the variable name “y” is held in the register REG1, and the variable value having the variable name “x” is held in the register REG3. In the clock cycle C4, the variable value having the variable name “z” is held in the register REG1.

Based on the binding result 94 sent from the binder 32, the RTL description generator 33 of FIG. 2 generates the RTL description 95 corresponding to the behavior description 91, and sends the RTL description 95 to the output apparatus 50 of FIG. 1.

Based on the simulation result 93 and the binding result 94, the designing apparatus 10 of FIG. 1 estimates the LSI's power consumption corresponding to the behavior description 91. As shown in FIG. 2, the designing apparatus 10 includes the input module 11, the calculation module 12, an estimation module 13, and an output module 14.

The input module 11 of FIG. 2 receives the command 92 from the input apparatus 40 of FIG. 1, receives the simulation result 93 from the simulator 20, and receives the binding result 94 containing the variable names in the respective clock cycles stored in the registers from the binder 32 of the high-level synthesis apparatus 30.

Based on the simulation result 93 and the binding result 94 that are inputted through the input module 11, the calculation module 12 of FIG. 2 calculates the rates of change of the variables stored in the registers in each one clock cycle. Specifically, the calculation module 12 generates a register table that indicates the respective variable values stored in the registers in the respective clock cycles, and calculates the rates of change using the register table. In other words, a rate of change in one clock cycle indicates the probability that a variable stored in a register varies in one time behavior of the LSI. The calculation module 12 will be explained later in detail.

Based on the rates of change calculated by the calculation module 12, the estimation module 13 of FIG. 2 estimates the power consumption of the LSI corresponding to the behavior description 91. The estimation module 13 will be explained later in detail.

The output module 14 of FIG. 2 outputs power consumption information 96 indicating the power consumption estimated by the estimation module 13 to the output apparatus 50 of FIG. 1.

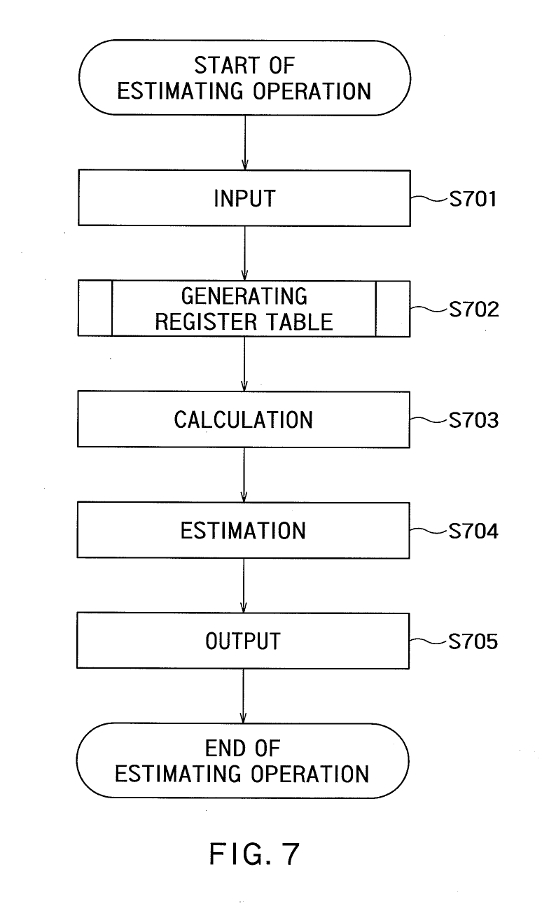

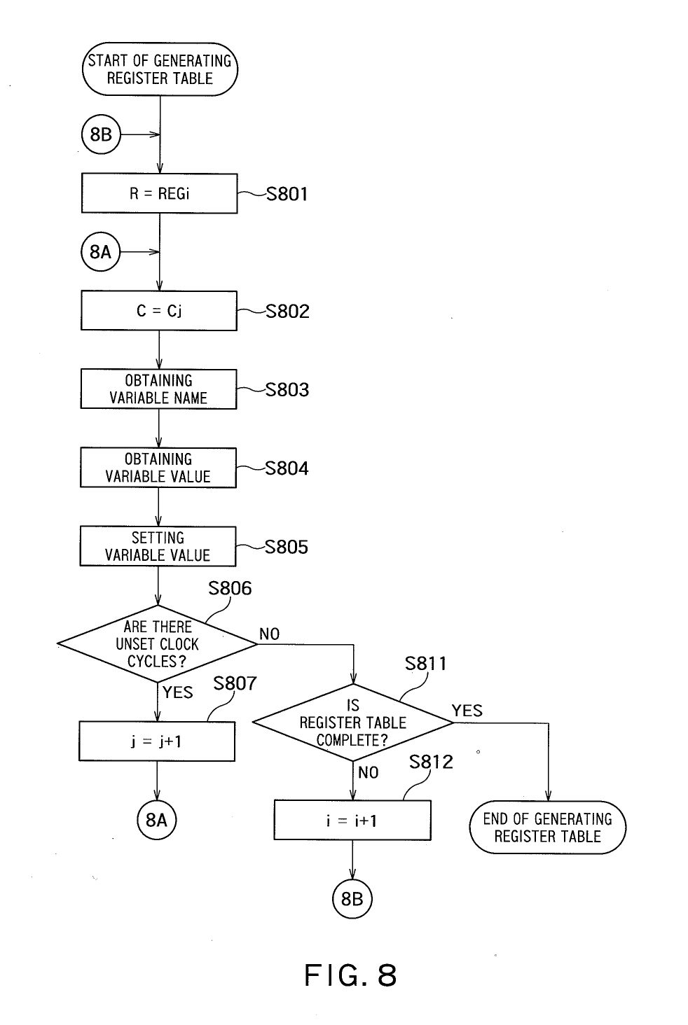

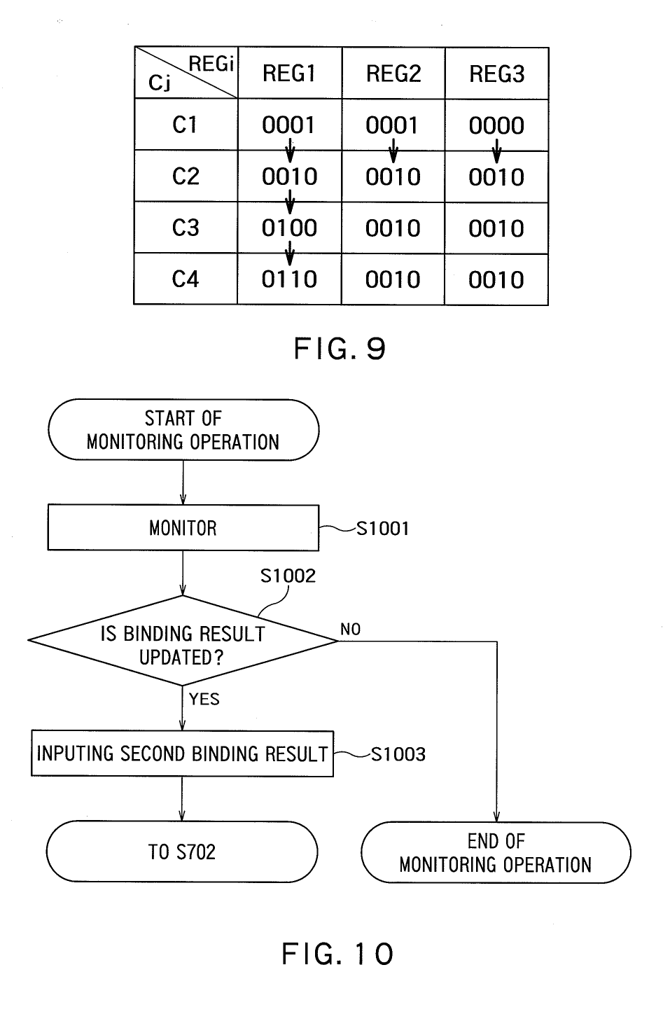

The operations to be performed by the designing apparatus according to the first embodiment are now explained. FIG. 7 is a flowchart showing the procedures in an estimating operation to be performed by the designing apparatus 10 of FIG. 1. FIG. 8 is a flowchart showing the procedures in the step of generating register table (S702) of FIG. 7. FIG. 9 is a schematic view of the register table.

<FIG. 7: Input (S701)> The input module 11 of FIG. 2 receives the command 92, the simulation result 93, and the binding result 94. The input module 11 may further receive the behavior description 91 and the CDFG.

<FIG. 7: Generating register table (S702)> The calculation module 12 of FIG. 2 generates a register table, based on the simulation result 93 and the binding result 94 that are inputted in the step of input (S701).

The step of generating register table (S702) of FIG. 7 is now explained.

<FIG. 8: S801> The calculation module 12 of FIG. 2 sets “REGi” in a variable “R”. The variable “R” represents the register to be examined. The initial value of “i” is 1. Therefore, the register to be examined is determined. For example, in the first-time S801, the register REG1 of FIG. 6 is the register to be examined.

<FIG. 8: S802> The calculation module of FIG. 2 sets “Cj” in a variable “C”. The variable “C” represents the clock cycle to be examined. The initial value of “j” is 1. Therefore, the clock cycle to be examined is determined. For example, in the first-time S802, the clock cycle C1 of FIG. 6 is the clock cycle to be examined.

<FIG. 8: Obtaining variable name (S803)> The calculation module 12 of FIG. 2 obtains, from the binding result 94, the variable name of the variable allocated to the register corresponding to the variable “R” in the clock cycle corresponding to the variable “C”. Therefore, the variable name of the variable allocated to the register in this clock cycle is determined. For example, in the first-time step of obtaining variable name (S803), the variable name “a” of the variable allocated to the register REG1 in the clock cycle C1 of FIG. 6 is obtained.

<FIG. 8: Obtaining variable value (S804)> The calculation module 12 of FIG. 2 obtains, from the simulation result 93, the variable value stored in the register corresponding to the variable “R”. Therefore, the variable value of the variable having the variable name obtained in the step of obtaining variable name (S803) is determined. For example, in the first-time step of obtaining variable value (S804), the variable value “0001” of the variable having the variable name “a” of FIG. 4 is obtained.

<FIG. 8: Setting variable value (S805)> The calculation module 12 of FIG. 2 sets the variable value obtained in the step of obtaining variable value (S804) in “REGi, Cj” in the register table corresponding to the variables “R” and “C”. For example, in the first-time step of setting variable value (S805), the variable value “0001” (see FIG. 4) of the variable having the variable name “a” of FIG. 3 is set in “REG1, C1” in the register table of FIG. 9.

<FIG. 8: S806> The calculation module 12 of FIG. 2 determines whether there are unset clock cycles. For example, when a variable value is not set in “REG1, C4” in the register table corresponding to the register REG1 to be examined and the end clock cycle C4 in the register table of FIG. 9, the calculation module 12 determines that there are unset clock cycles. When a variable value is set in “REG1, C4” in the register table, the calculation module 12 determines that there are not unset clock cycles. When the calculation module 12 determines that there are unset clock cycles (S806-YES), S807 is carried out. When the calculation module 12 determines that there are not unset clock cycles (S806-NO), S811 is carried out.

<FIG. 8: S807> The calculation module 12 of FIG. 2 sets “j+1” in “j”. Therefore, the clock cycle to be subjected to the step of generating register table (S702) of FIG. 7 is changed. After S807, S802 is carried out.

<FIG. 8: S811> The calculation module 12 of FIG. 2 determines whether the register table is complete. For example, when a variable value is not set in “REG3, C4” in the register table corresponding to the end register REG3 and the end clock cycle C4 in the register table of FIG. 9, the calculation module 12 determines that the register table is incomplete. When a variable value is set in “REG3, C4” in the register table, the calculation module 12 determines that the register table is complete. When the register table is determined to be incomplete (S811-NO), S812 is carried out. When the register table is determined to be complete (S811-YES), the step of generating register table (S702) of FIG. 7 comes to an end. After the step of generating register table (S702) of FIG. 7 ends, the step of calculation (S703) of FIG. 7 is carried out.

<FIG. 8: S812> The calculation module 12 of FIG. 2 sets “i+1” in “i”. Therefore, the register to be examined is changed. After S812, S801 is carried out.

To sum up, the calculation module 12 of FIG. 2 generates the register table of FIG. 9 that defines variable values, using parameters that are the types of registers and the clock cycles contained in the binding result 94. The calculation module 12 obtains the variable names from the binding result 94, and obtains the variable values corresponding to the obtained variable names from the simulation result 93. The calculation module 12 sets the obtained variable values in the register table.

When the step of generating register table (S702) of FIG. 7 comes to an end, the register table of FIG. 9 is completed.

<FIG. 7: Calculation (S703)> Using the register table generated in the step of generating register table (S702), the calculation module 12 of FIG. 2 calculates a rate of change. Specifically, the calculation module 12 calculates a rate of change, using the equation 1. In the equation 1, “CLK” represents the number of clock cycles required for the behavior expressed by the behavior description 91, and “CNT” represents the number of times the variable value stored in a register has changed. In other words, the denominator of the equation 1 represents the clock cycle periods to be calculated in the step of calculation (S703). The arrows in FIG. 9 indicate that the variables change. For example, as for the register REG1 of FIG. 9, the number of times a change occurs in the clock cycles C1 through C4 (the clock cycle periods being 3) is 3 (see “REG1, C1” through “REG1, C4” in the register table), and accordingly, the rate of change P is 1. As for the register REG2, the number of times a change occurs in the clock cycles C1 through C4 (the clock cycle periods being 3) is 1 (see “REG2, C1” and “REG2, C2” in the register table), and accordingly, the rate of change P is ⅓. As for the register REG3, the number of times a change occurs in the clock cycles C1 through C4 (the clock cycle periods being 3) is 1 (see “REG3, C1” and “REG3, C2” in the register table), and accordingly, the rate of change P is ⅓.

$$P = \frac{CNT}{CNT - 1} \qquad [ Equation 1 ]$$

<FIG. 7: Estimation (S704)> Based on the rates of change P calculated in the step of calculation (S703), the estimation module 13 of FIG. 2 estimates the LSI's power consumption required for the behavior expressed by the behavior description 91. Specifically, the estimation module 13 uses a library including the power consumption information 96 containing the power consumption of the registers in the LSI, of the memory, and of the arithmetic units, and the rates (toggle rates) of change of the variable values in the registers and in the arithmetic units to calculate the switching powers of the registers and of the arithmetic units. The estimation module 13 adds up the respective switching powers. The result of the addition indicates the estimated value of the LSI's power consumption.

<FIG. 7: Output (S705)> The output module 14 of FIG. 2 sends the power consumption information 96 indicating the power consumption estimated in the step of estimation (S704), to an output apparatus (not shown). When the step of output (S705) ends, the estimating operation of FIG. 7 ends.

To sum up, the designing apparatus 10 according to the first embodiment does not estimate the power consumption in a simulation of a netlist obtained from the RTL description 95, but estimates the power consumption with the use of the binding result 94 and the simulation result 93. Accordingly, the period of time required for estimating the LSI's power consumption can be shortened.

### Second Embodiment

A second embodiment is described in detail, with reference to the accompanying drawings. In the first embodiment, the input module 11 of FIG. 2 receives the binding result 94 sent from the binder 32. In the second embodiment, on the other hand, the input module 11 requests the binding result 94 from the binder 32 at predetermined intervals. Explanation of the same aspects as those of the above described embodiment is not repeated herein.

The structure of the designing apparatus according to the second embodiment is the same as the designing apparatus according to the first embodiment (see FIG. 2).

The operations to be performed by the designing apparatus according to the second embodiment are explained. FIG. 10 is a flowchart showing the procedures in a monitoring operation according to the second embodiment.

The estimating operation according to the second embodiment is the same as the estimating operation of FIG. 7. The monitoring operation of FIG. 10 is performed in parallel with the estimating operation of FIG. 7 at predetermined intervals.

<FIG. 10: Monitor (S1001)> The input module 11 of FIG. 2 monitors the binder 32 of the high-level synthesis apparatus 30 at predetermined intervals. Specifically, the input module 11 compares the binding result 94 that is inputted in the step of input (S701) of FIG. 7 (hereinafter referred to as the “first binding result”) with the binding result 94 obtained when the step of monitor (S1001) is carried out (hereinafter referred to as the “second binding result”), and determines whether the two results differ.

<FIG. 10: S1002> When the binding result has been updated (that is, when the first binding result differs from the second binding result) (S1002-YES), the step of inputting second binding result (S1003) is carried out. When the binding result has not been updated (that is, when the first binding result is equal to the second binding result) (S1002-NO), the monitoring operation comes to an end.

<FIG. 10: Inputting second binding result (S1003)> The input module 11 of FIG. 2 receives the second binding result from the binder 32. After the step of inputting second binding result (S1003) is carried out, the step of generating register table (S702) of FIG. 7 is carried out. In the step of generating register table (S702), the second binding result is used, instead of the first binding result.

In other words, the designing apparatus 10 according to the second embodiment estimates the power consumption based on the latest binding result 94. Accordingly, even if the user does not input a command to perform the estimating operation again when the binding result 94 is updated, the power consumption information 96 corresponding to the updated binding result 94 can be obtained.

According to the present embodiment, the designing apparatus 10 does not estimate the LSI's power consumption in a simulation of a netlist obtained from the RTL description 95, but estimates the LSI's power consumption with the use of the binding result 94 and the simulation result 93. Accordingly, the period of time required for estimating the LSI's power consumption can be shortened.

In the present embodiment, in the step of calculation (S703) of FIG. 7, the rates of change P are calculated based on the number of times the respective 4-bit variable values stored in the registers have changed. However, the scope of the present invention is not limited to that. The present invention can also be applied to a case where the rate of change P of each bit of the variables stored in the registers is calculated. In this case, the accuracy of the estimate of the LSI's power consumption can be improved. For example, as for the first bit of the variable value in the register REG1 in the register table of FIG. 9, the number of times the variable value changes in the clock cycles C1 through C4 (the clock cycle periods being 3) is 1 (see “REG1, C1” and “REG1, C2” in the register table), and accordingly, the rate of change P is ⅓. As for the second bit of the variable value in the register REG1, the number of times the variable value changes in the clock cycles C1 through C4 (the clock cycle periods being 3) is 3 (see “REG1, C1” through “REG1, C4” in the register table), and accordingly, the rate of change P is 1. As for the third bit of the variable value in the register REG1, the number of times the variable value changes in the clock cycles C1 through C4 (the clock cycle periods being 3) is 1 (see “REG1, C2” and “REG1, C3” in the register table), and accordingly, the rate of change P is ⅓. As for the fourth bit of the variable value in the register REG1, the number of times the variable value changes in the clock cycles C1 through C4 (the clock cycle periods being 3) is 0, and accordingly, the rate of change P is 0.

In the present embodiment, the rates of change P of the variable values stored in the registers have been described. However, the scope of the present invention is not limited to them. The present invention can also be applied to the rates of change of the variable values used in the arithmetic units.

At least a portion of a designing apparatus 10 according to the above-described embodiments may be composed of hardware or software. When at least a portion of the designing apparatus 10 is composed of software, a program for executing at least some functions of the designing apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the designing apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A designing apparatus used with a simulator simulating a behavior description describing behavior of a semiconductor integrated circuit, and a high-level synthesis apparatus allocating a variable described in the behavior description to a register and generating a register transfer level description based on the allocated variable, the apparatus comprising:
an input module configured to input a simulation result of the simulator and a binding result comprising a variable name of the allocated variable to be stored into the register;
a calculation module configured to calculate a rate of change of the allocated variable to be stored into the register in one clock cycle based on the simulation result and the binding result; and
an estimation module configured to estimate power consumption of the semiconductor integrated circuit corresponding to the behavior description based on the rate.

2. The apparatus of claim 1, wherein the calculation module generates a register table comprising a variable value of the allocated variable and calculates the rate using the register table.

3. The apparatus of claim 2, wherein the calculation module uses a kind of the register in the binding result and the clock cycle as parameters to generate the register table, obtains the variable name from the binding result, obtains the variable value corresponding to the obtained variable name from the simulation result, and sets the obtained variable value into the register table.

4. The apparatus of claim 1, wherein the calculation module calculates the rate of the variable to be stored into the register table in one clock cycle by a bit.

5. The apparatus of claim 2, wherein the calculation module calculates the rate of the variable to be stored into the register table in one clock cycle by a bit.

6. The apparatus of claim 3, wherein the calculation module calculates the rate of the variable to be stored into the register table in one clock cycle by a bit.

7. The apparatus of claim 1, wherein the input module monitors the high-level synthesis apparatus at predetermined intervals and inputs an updated binding result when the binding result is updated by the high-level synthesis apparatus.

8. The apparatus of claim 2, wherein the input module monitors the high-level synthesis apparatus at predetermined intervals and inputs an updated binding result when the binding result is updated by the high-level synthesis apparatus.

9. The apparatus of claim 3, wherein the input module monitors the high-level synthesis apparatus at predetermined intervals and inputs an updated binding result when the binding result is updated by the high-level synthesis apparatus.

10. The apparatus of claim 4, wherein the input module monitors the high-level synthesis apparatus at predetermined intervals and inputs an updated binding result when the binding result is updated by the high-level synthesis apparatus.

11. The apparatus of claim 5, wherein the input module monitors the high-level synthesis apparatus at predetermined intervals and inputs an updated binding result when the binding result is updated by the high-level synthesis apparatus.

12. The apparatus of claim 6, wherein the input module monitors the high-level synthesis apparatus at predetermined intervals and inputs an updated binding result when the binding result is updated by the high-level synthesis apparatus.

13. A method for causing a computer-processor to design a semiconductor integrated circuit, the method used with a behavior description describing behavior of the semiconductor integrated circuit, and a high-level synthesis allocating a variable described in the behavior description to a register and generating a register transfer level description based on the allocated variable, the method comprising:
inputting a simulation result and a binding result comprising a variable name of the allocated variable to be stored into the register;
calculating a rate of change of the allocated variable to be stored into the register in one clock cycle based on the simulation result and the binding result; and
estimating power consumption of the semiconductor integrated circuit corresponding to the behavior description based on the rate.

14. The method of claim 13, wherein in calculating the rate, a register table comprising a variable value of the allocated variable is generated and the rate is calculated using the register table.

15. The method of claim 14, wherein in calculating the rate, a kind of the register in the binding result and the clock cycle is used as parameters to generate the register table, the variable name is obtained from the binding result, the variable value corresponding to the obtained variable name is obtained from the simulation result, and the obtained variable value is set into the register table.

16. The method of claim 13, wherein in calculating the rate, the rate of the variable to be stored into the register table in one clock cycle is calculated by a bit.

17. The method of claim 14, wherein in calculating the rate, the rate of the variable to be stored into the register table in one clock cycle is calculated by a bit.

18. The method of claim 15, wherein in calculating the rate, the rate of the variable to be stored into the register table in one clock cycle is calculated by a bit.

19. The method of claim 13, wherein in inputting the simulation result and the binding result, the high-level synthesis at predetermined intervals is monitored and an updated binding result is inputted when the binding result is updated in the high-level synthesis.

20. A computer readable medium comprising a computer program code for designing a semiconductor integrated circuit, the computer program code used with a behavior description describing behavior of the semiconductor integrated circuit, and a high-level synthesis allocating a variable described in the behavior description to a register and generating a register transfer level description based on the allocated variable, the computer program code comprising:
inputting a simulation result and a binding result comprising a variable name of the allocated variable to be stored into the register;
calculating a rate of change of the allocated variable to be stored into the register in one clock cycle based on the simulation result and the binding result; and
estimating power consumption of the semiconductor integrated circuit corresponding to the behavior description based on the rate.
